(19) United States
(12) Patent Application Publication
(10) Pub. No.: US 2022/0386806 A1
(43) Pub. Date: Dec. 8, 2022

(54) SMALL HOME APPLIANCE, AND METHOD FOR PERFORMING COMMUNICATION IN SMALL HOME APPLIANCE

(71) Applicant: LG ELECTRONICS INC., Seoul (KR)

(72) Inventor: Gwang Rok Kim, Seoul (KR)

(21) Appl. No.: 17/770,198

(22) PCT Filed: Sep. 29, 2020
(86) PCT No.: PCT/KR2020/013399

§ 371 Date: Apr. 19, 2022

(30) Foreign Application Priority Data
Oct. 23, 2019 (KR) 10-2019-0132243

(51) Int. Cl. A47J 36/32; H04B 5/00

(52) U.S. Cl. CPC A47J 36/32; H04B 5/0037; H04B 5/0031; H04B 5/0081

(57) ABSTRACT

A small home appliance includes a coil for power reception and communication, a communication unit which performs wireless communication with a wireless power transmission device by using the coil, and a controller which receives wireless power from the wireless power transmission device by the coil, receives a zero crossing interrupt signal from the wireless power transmission device, and determines a communication period of the communication unit according to the zero crossing interrupt signal.

### TECHNICAL FIELD

The present disclosure relates to a small home appliance and a method for performing communication with the small home appliance.

### BACKGROUND ART

Recently, electronic products using a wireless power transfer (WPT) technology have been developed. Wireless power transfer technology is a technology for wirelessly transferring power between a power source and an electronic device. As an example, wireless power transfer technology allows you to charge the battery of a wireless terminal, such as a smartphone or tablet, by simply placing the wireless terminal on a wireless charging pad, thereby providing greater mobility, convenience, and safety compared to a wired charging environment in which an existing wired charging connector is used. Wireless power transfer technology is expected to replace an existing wired power transmission environment in various fields such as electric vehicles, various wearable devices such as Bluetooth earphones and 3D glasses, home appliances, furniture, underground facilities, buildings, medical devices, robots, and leisure.

A wireless power transfer method is referred to as a contactless power transfer method, a power transfer method having no point of contact, or a wireless charging method. A wireless power transfer system may be composed of a wireless power transmitter for supplying electric energy in the wireless power transfer method, and a wireless power receiver for receiving electric energy wirelessly supplied from the wireless power transmitter and supplying power to a power receiving device such as a battery cell.

Wireless power transfer technology includes various methods such as a method of transferring power through magnetic coupling, a method of transferring power through radio frequency (RF), a method of transferring power through microwaves, and a method of transferring power through ultrasonic waves.

Such a wireless power transfer technology is being applied to a small electric appliance in addition to wireless charging of a wireless terminal.

A wireless power technology is mainly divided into two categories such as a short distance and a long distance. In a short distance or non-radiative technology, power is generally transmitted over a short distance by a magnetic field using inductive coupling between coils of wire. Inductive coupling is the most widely used wireless technology.

FIG. 1 is a view illustrating an example of a small home appliance employing a conventional wireless power transfer technology.

Referring to FIG. 1, an electric kettle is illustrated as the small home appliance.

Since the electric kettle 1 employs the wireless power transfer technology, the electric kettle is required to wirelessly receive power. To this end, the electric kettle 1 includes an antenna coil 2 for communication, and a coil 3 for power reception. The antenna coil 2 for communication and the coil 3 for power reception may be located close to each other due to the small internal area of the small home appliance. The coil 3 for power reception may receive power, and the antenna coil 2 for communication may, for example, be an antenna for a near field communication. The electric kettle 1 may perform near field communication with a wireless power transmission device 6 by using the antenna coil 2 for communication.

However, the magnitude of voltage induced in the antenna coil 2 for communication may be greater than the magnitude of voltage induced in the coil 3 for power reception. Accordingly, since the antenna coil 2 for communication and the coil 3 for power reception are located close to each other in the small space of the small home appliance, magnetic field interference occurs in the antenna coil 2 for communication due to the coil 3 for power reception, so communication performance deteriorates.

### DISCLOSURE

### Technical Problem

The present disclosure is intended to propose a small home appliance in which the problem of communication performance deterioration due to interference between a coil for power reception and a coil for communication in a conventional small home appliance is solved.

The present disclosure is intended to propose a small home appliance in which the space issue of the small home appliance can be solved.

The present disclosure is intended to propose a small home appliance and a method for performing communication with the small home appliance in which both power reception and communication can be performed by using one coil.

The objectives of the present disclosure are not limited to the objectives mentioned above, and, other objectives not mentioned will be clearly understood by those skilled in the art to which the present disclosure belongs from the following description.

### Technical Solution

According to an embodiment, a small home appliance includes: a coil for power reception and communication; a communication unit which performs wireless communication with another electronic device by using the coil; and a controller which receives wireless power from a wireless power transmission device by using the coil, receives a zero crossing interrupt signal related to the wireless power from the wireless power transmission device, and determines a communication period for communication by using the coil according to the zero crossing interrupt signal.

The small home appliance may further include a switch located between the coil and the communication unit, wherein the controller may control the switch according to the zero crossing interrupt signal.

The controller may generate a communication control signal according to the zero crossing interrupt signal and transmit the communication control signal to the communication unit, and the communication unit may operate according to the communication control signal.

The wireless power transmission device may include a coil for power transmission which generates a time-varying electromagnetic field due to commercial power, a zero crossing detector which outputs a detected signal by detecting zero crossing of the commercial power, and another controller which generates the zero crossing interrupt signal on the basis of the detected signal.

The wireless power transmission device may further include: an antenna for communication, and another communication unit which communicates with the communication unit through the antenna for communication.

The zero crossing interrupt signal may have a period of 8.3 ms.

The zero crossing interrupt signal may have a pulse width of 2 ms.

The small electric appliance may include an electric kettle, a blender, and a toaster.

The small home appliance may be the electric kettle, and the coil for power reception and communication may be disposed on the lower part of the electric kettle.

According to the embodiment, a method for performing communication between the small home appliance including the coil for power reception and communication and the wireless power transmission device may include: a step at which the wireless power transmission device transmits a zero crossing interrupt signal related to wireless power to the small home appliance when the wireless power transmission device transmits the wireless power; a step at which the small home appliance receives the zero crossing interrupt signal; and a step at which the small home appliance determines the communication period by using the coil according to the zero crossing interrupt signal.

The step of determining the communication period may include a step at which the small home appliance controls the switch located between the coil and the communication unit of the small home appliance according to the zero crossing interrupt signal.

The step of determining the communication period may include: a step at which the small home appliance generates the communication control signal according to the zero crossing interrupt signal; a step at which the small home appliance transmits the communication control signal to the communication unit of the small home appliance; and a step at which the communication unit of the small home appliance operates according to the communication control signal.

The method for performing communication may further include: a step at which zero crossing of commercial power is detected when the wireless power transmission device transmits wireless power by using the commercial power, and a step at which the wireless power transmission device generates the zero crossing interrupt signal according to the detected zero crossing.

### Advantageous Effects

According to the embodiment of the present disclosure, one coil is used for power and antenna, thereby solving the conventional problem of communication performance deterioration due to interference between two coils.

According to the embodiment of the present disclosure, coil mounting space is reduced, thereby improving the beauty of the small home appliance and miniaturizing the small home appliance.

### DESCRIPTION OF DRAWINGS

FIG. 1 is a view illustrating an example of a small home appliance to which a conventional wireless power transfer system is applied.

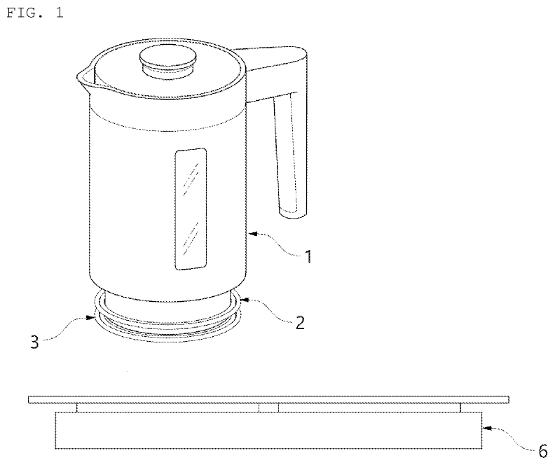

FIG. 2 is a perspective view of an example of an electronic device employing a wireless power transfer system according to an embodiment of the present disclosure.

FIG. 3 is a block diagram of a small home appliance according to the embodiment of the present disclosure.

FIG. 4 illustrates a zero crossing interrupt signal according to the embodiment of the present disclosure.

FIG. 5 illustrates a flowchart of a method of performing communication between the small home appliance and a wireless power transmission device according to the embodiment of the present disclosure.

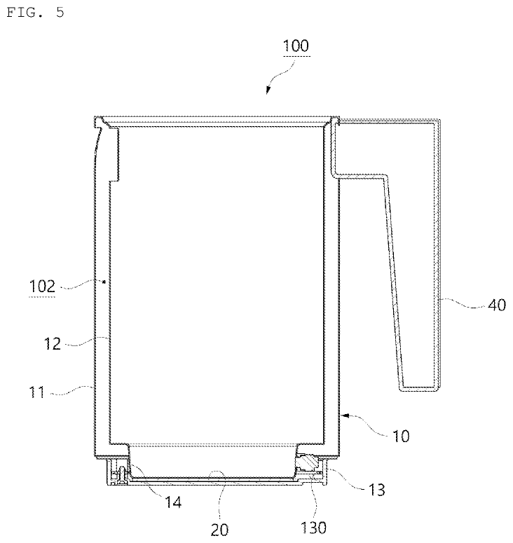

FIG. 6 is a sectional view of an electric kettle which is an example of the small home appliance according to the embodiment of the present disclosure.

FIG. 7 is a sectional perspective view of the electric kettle of FIG. 6.

FIG. 8 is a sectional perspective view of the lower part of the electric kettle of FIG. 6.

### MODE FOR INVENTION

Hereinbelow, detailed embodiments of the present disclosure will be described in detail with reference to the accompanying drawings. However, the present disclosure cannot be said to be limited to the embodiments in which the spirit of the present disclosure is presented, and other embodiments which are included in other inventions degenerated by the addition, change, and deletion of other components or within the scope of the present disclosure may be easily proposed.

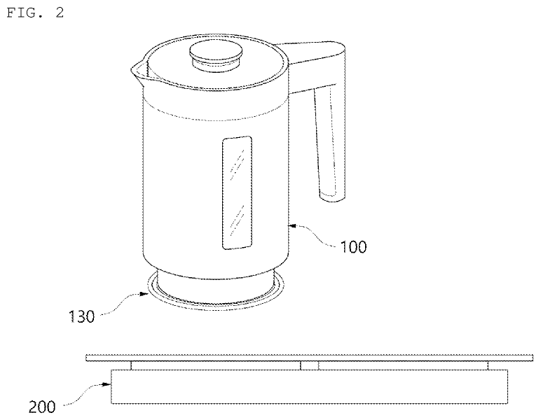

FIG. 2 is a perspective view of an example of an electronic device employing a wireless power transfer system according to an embodiment of the present disclosure.

As an example of an electronic device, an electric kettle 100 is illustrated.

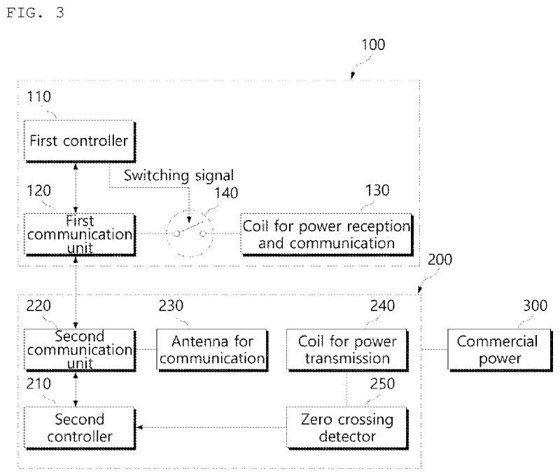

The electric kettle 100 may wirelessly receive power from a wireless power transmission device 200. A coil 130 for power reception and communication (see FIG. 3) of the electric kettle 100 may receive power from the wireless power transmission device 200 according to an electromagnetic induction method. The electromagnetic induction method is a method using an induction phenomenon between the primary and secondary coils of a transformer, and uses a frequency of several MHz. A transmission distance of the electromagnetic induction method is several mm or less, and a transmission efficiency thereof is about 90% when the transmission distance is less than 1 mm.

In this case, when the electric kettle 100 is disposed close to the wireless power transmission device 200 within a predetermined distance, a current is applied to the coil of the wireless power transmission device 200 to form a magnetic field due to the flow of the current.

When the electric kettle 100 is located in the range of the magnetic field of the wireless power transmission device 200, a current is induced in the coil of the electric kettle 100. Accordingly, the electric kettle 100 may obtain AC power and convert the AC power into DC power such that the DC power can be supplied to components of the electric kettle 100.

FIG. 3 is a block diagram of a small home appliance according to the embodiment of the present disclosure.

The small home appliance 100 may include the electric kettle, a blender, and a toaster. Furthermore, the small home appliance 100 may wirelessly receive power from the wireless power transmission device 200.

The small home appliance 100 according to the embodiment of the present disclosure may include a first electronic controller 110, a first communication unit 120, and the coil 130 for power reception and communication.

The small home appliance 100 may receive wireless power and may perform communication by using the coil 130 for power reception and communication. That is, the small home appliance 100 may perform both the reception of the wireless power and communication by using one coil.

Specifically, the first communication unit 120 may perform NFC communication by using the coil 130 for power reception and communication. Additionally, the first controller 110 may use voltage induced through the coil 130 for power reception and communication as power.

The first controller 110 may use the coil 130 for power reception and communication for communication according to a predetermined period. That is, the first controller 110 may determine a communication period by the coil 130. That is, the first controller 110 may use the coil 130 for communication in a time period in which wireless power is not received through the coil 130.

To this end, the first controller 110 may receive a zero crossing interrupt signal related to the wireless power from the wireless power transmission device 200, and may determine a communication period by using the coil according to the zero crossing interrupt signal.

The wireless power transmission device 200 may include a second electronic controller 210, a second communication unit 220, an antenna 230 for communication, a coil 240 for power transmission, and a zero crossing detector 250.

Since the wireless power transmission device 200 does not have restriction of small space like the small home appliance 100, the wireless power transmission device 200 may include the antenna 230 for communication and the coil 240 for power transmission. Accordingly, the second communication unit 220 may use the antenna 230 for communication exclusively for communication. Furthermore, the second controller 210 may use the coil 240 for power transmission exclusively for power transmission.

The coil 240 for power transmission may generate a time-varying electromagnetic field due to commercial power 300. The commercial power 300 is AC power and thus has a zero crossing point. That is, commercial power is 220 AC 60 Hz in Korea and has 120 voltage zero crossing points.

Accordingly, the electromagnetic field generated due to the commercial power 300 may also have a zero crossing point. That is, in the zero crossing point of the time-varying electromagnetic field, wireless power may not be transmitted to the small home appliance 100.

The zero crossing detector 250 may detect the zero crossing point of the commercial power and may provide or output a detected signal to the second controller 210. The zero crossing detector 250 is not a necessary component of the small home appliance of the present disclosure, and may be included in the small home appliance 100 which is a wireless power reception device. The second controller 210 may generate a zero crossing interrupt signal on the basis of the detected signal output from the zero crossing detector 250.

Meanwhile, since the commercial power 300 has a known frequency, the second controller 210 knows in advance the period of the commercial power. Accordingly, the second controller 210 may generate a zero crossing interrupt signal according to of the known period of the commercial power.

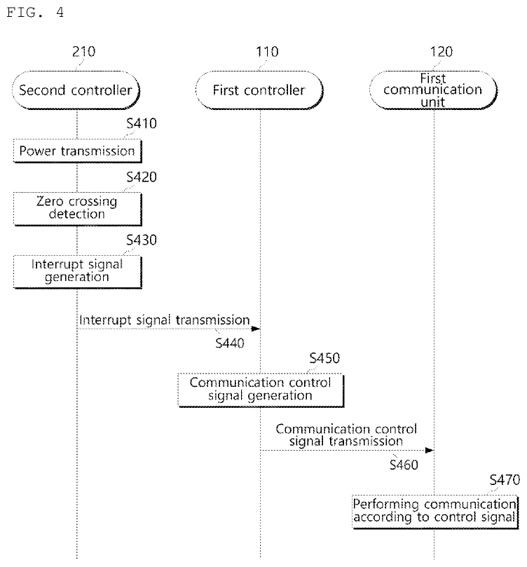

FIG. 4 illustrates a zero crossing interrupt signal according to the embodiment of the present disclosure.

Referring to FIG. 4, the zero crossing interrupt signal may be generated on the basis of the zero crossing of wireless power (WPT power in FIG. 4). As described above, the zero crossing of commercial power or wireless power may be known in advance by the second controller 210 of the wireless power transmission device 200 or may be detected by the zero crossing detector 250. For example, the zero crossing detector 250 may detect a sine waveform transition from positive and negative sections of wireless power.

The zero crossing interrupt signal may be generated based on the zero crossing of commercial power. As illustrated in FIG. 4, the zero crossing interrupt signal may be a square wave signal having a period of 8.3 ms. Furthermore, the zero crossing interrupt signal may have a pulse width of 2 ms. The pulse width of the zero crossing interrupt signal may correspond to the negative section of wireless power. It is clear that embodiments of the present disclosure are not limited thereto.

The zero crossing interrupt signal may have a pulse width corresponding to the negative section of wireless power. In the negative section of wireless power, the coil 130 for power reception and communication of the small home appliance may be used for short distance communication (for example, NFC communication).

Referring back to FIG. 4, the second controller 210 of the wireless power transmission device 200 may transmit a zero crossing interrupt signal to the small home appliance 100 through the second communication unit 220 on the basis of the zero crossing of wireless power.

When the first controller 110 of the small home appliance 100 receives the zero crossing interrupt signal through the first communication unit 120, the first controller 110 may determine a communication period by using the coil 130 according to the zero crossing interrupt signal.

The first controller 110 of the small home appliance 100 may allow the first communication unit 120 to perform communication according to the determined communication period.

According to the embodiment, the small home appliance 100 may further include a switch 140 located between the coil 130 for power reception and communication and the first communication unit 120. In this case, the first controller 110 may control the switch 140 according to the zero crossing interrupt signal.

Specifically, the first controller 110 may control the switch 140 according to the pulse of the zero crossing interrupt signal and may connect the coil 130 with the first communication unit 120. For example, the first controller 110 may control the switch 140 by providing a switching signal to the switch 140. When the first communication unit 120 is connected with the coil 130 through the switch 140, the first communication unit 120 may transmit an NFC signal to the wireless power transmission device 200.

According to another embodiment, when the first controller 110 of the small home appliance 100 receives the zero crossing interrupt signal from the wireless power transmission device 200, the first controller 110 may generate a communication control signal. In this case, the communication control signal may be a signal indicating a communication period. After generating the communication control signal, the first controller 110 of the small home appliance 100 may transmit the communication control signal to the first communication unit 120. When the first communication unit 120 receives the communication control signal from the first controller 110, the first communication unit 120 may perform communication according to the communication control signal.

The small home appliance 100 may be an electric kettle, and the coil 130 for power reception and communication may be disposed on a lower part of the electric kettle 100.

FIG. 4 illustrates a flowchart of the method of performing communication between the small home appliance and the wireless power transmission device according to the embodiment of the present disclosure.

Referring to FIG. 4, the second controller 210 of the wireless power transmission device 200 may transmit wireless power to the small home appliance 100. The wireless power transmission device 200 may transmit wireless power by using a coil for wireless power transmission (S410). When the second controller 210 of the wireless power transmission device 200 transmits wireless power, the second controller 210 may detect the zero crossing of wireless power (S420). The second controller 210 of the wireless power transmission device 200 may generate a zero crossing interrupt signal on the basis of the detected zero crossing of wireless power (S430).

After generating the zero crossing interrupt signal, the second controller 210 of the wireless power transmission device 200 may transmit the zero crossing interrupt signal to the small home appliance 100 (S440).

After receiving the zero crossing interrupt signal from the wireless power transmission device 200, the first controller 110 of the small home appliance 100 may generate the communication control signal (S450). In this case, the communication control signal may be a signal indicating a communication period. After generating the communication control signal, the first controller 110 of the small home appliance 100 may transmit the communication control signal to the first communication unit 120 (S460). When receiving the communication control signal from the first controller 110, the first communication unit 120 may perform communication according to the communication control signal.

According to the another embodiment, the first controller 110 of the small home appliance 100 may control the switch 140 disposed between the first communication unit 120 and the coil 130 for power reception and communication according to the zero crossing interrupt signal. Specifically, the first controller 110 may control the switch 140 by corresponding to the pulse of the zero crossing interrupt signal and may connect the coil 130 with the first communication unit 120. When the first communication unit 120 is connected with the coil 130 through the switch 140, the first communication unit 120 may transmit an NFC signal to the wireless power transmission device 200.

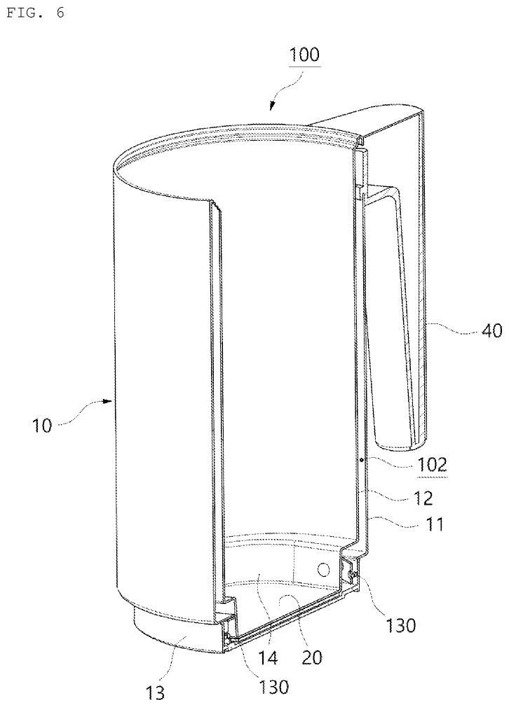

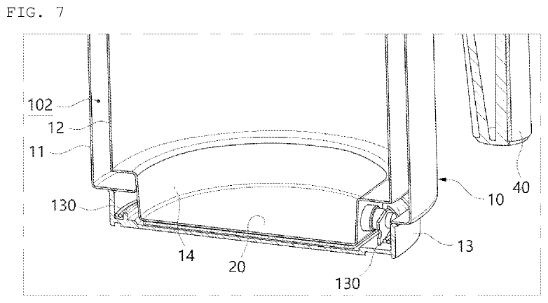

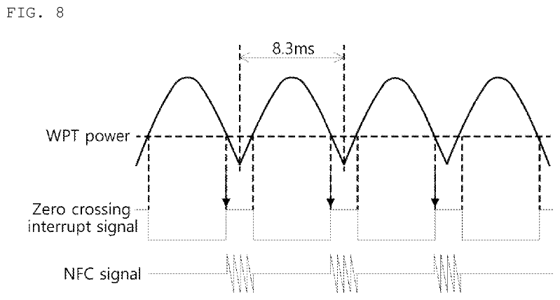

FIG. 6 is a sectional view of an electric kettle which is an example of the small home appliance according to the embodiment of the present disclosure. FIG. 7 is a sectional perspective view of the electric kettle of FIG. 6, and FIG. 8 is a sectional perspective view of the lower part of the electric kettle of FIG. 6.

Referring to FIGS. 6 to 8, the electric kettle 100 may include a body 10. The body 10 may be configured to have a cylindrical shape. A heater (not shown) may be installed on the lower surface 20 of the body 10. The heater may receive power supplied from the electric kettle 100 and may generate heat. A handle 40 may be formed on a side of the body 10 by protruding therefrom.

Contents such as water may be received in the body 10, and the lower surface 20 of the body 10 may be heated by the heater.

The body 10 may include an inner body 12 and an outer body 11 and may have space defined between the inner body 12 and the outer body 11, so the body 10 may have a structure having a significantly improved insulation performance compared to a single-wall structure.

Both the inner body 12 and the outer body 11 may be formed of the same stainless materials, wherein the outer body 11 may constitute the exterior of the body 10, and the inner body 12 may define the space in which water is received. The inner body 12 may have a diameter smaller than the diameter of the outer body 11, and accordingly, the inner body 12 may be provided to be received in the outer body 11. Accordingly, the space 102 may be defined between the outer body 11 and the inner body 12.

An air layer may be formed in the space 102 defined between the outer body 11 and the inner body 12, so heat may be prevented from being directly transferred to the outer body 11. Accordingly, the space 102 may be referred to as insulation space 102. Additionally, even in a state in which water received in the inner body 12 is heated to be hot, the outer body 11 may maintain a relatively low temperature.

The body 10 may be formed in such a manner that the upper and lower ends of the outer body 11 and the inner body 12 formed in cylindrical shapes are coupled to each other. For example, the upper and lower ends of the outer body 11 and the inner body 12 may be connected to each other by welding while superimposed on each other. In this case, except for the upper and lower ends of the outer body 11 and the inner body 12, remaining portions thereof may be spaced apart by a predetermined interval from each other to have an insulating structure.

The structure of the upper end of the body 10 will be described in more detail. A outer lower end part 13 may be formed on the lower end of the outer body 11. The outer lower end part 13 may extend downward to form the lower end of the outer body 11, and may be formed in a shape stepped inward.

An inner lower end part 14 may be formed on the lower end of the inner body 12. The inner lower end part 14 may be formed by extending downward to form the lower end of the inner body 12. Furthermore, the inner lower end part 14 may be in surface contact with the outer lower end part 13. In a state in which the outer lower end part 13 and the inner lower end part 14 are coupled to each other, the coil 130 for power reception and communication of the electric kettle 100 may be installed in space between the outer lower end part 13 and the inner lower end part 14.

As described above, as a distance between the coil 130 of the electric kettle 100 and the coil of the wireless power transmission device 200 decreases, power transmission efficiency therebetween increases. Accordingly, when the coil 130 of the electric kettle 100 is placed on the wireless power transmission device 200, the coil 130 may be disposed in the space between the outer lower end part 13 and the inner lower end part 14 close to the coil of the wireless power transmission device 200.

In addition, a humidity sensor 110 may be installed in the space between the outer lower end part 13 and the inner lower end part 14. The humidity sensor 110 may be installed to be exposed to space of the body 10 in which water is received. Specifically, the humidity sensor 110 may be installed on a side portion of the inner lower end part 14 such that the humidity sensor 110 is exposed to the space of the body 10 in which water is received. Accordingly, the humidity sensor 110 may measure the humidity of the space of the body 10 in which water is received.

Hereinafter, in the electric kettle configured as described above, a component for determining whether contents are present the space of the body and an operation method thereof on the basis of humidity measured by the humidity sensor will be described.

Although the embodiments of the present disclosure have been described with reference to the accompanying drawings, the present disclosure is not limited to the above embodiments and may be manufactured in various different forms. Those skilled in the art to which the present disclosure belongs will be able to understand that the present disclosure may be embodied in other specific forms without changing the technical idea or essential characteristics of the present disclosure. Therefore, it should be understood that the embodiments described above are illustrative in all respects and not restrictive.

1. A small home appliance comprising:
a coil for power reception and communication;
a communication unit to perform wireless communication with a wireless power transmission device using the coil; and
a controller configured to receive wireless power from the wireless power transmission device using the coil, receive a zero crossing interrupt signal related to the wireless power from the wireless power transmission device, and determine a communication period for communication using the coil based on the zero crossing interrupt signal.

2. The small home appliance of claim 1, further comprising:
a switch, wherein the controller is configured to control the switch based on the zero crossing interrupt signal.

3. The small home appliance of claim 2, wherein the controller is configured to generate a communication control signal based on the zero crossing interrupt signal and transmit the communication control signal to the communication unit,
wherein the communication unit operates based on the communication control signal.

4. The small home appliance of claim 1, wherein the wireless power transmission device comprises: a coil for power transmission to transmit a time-varying electromagnetic field generated using commercial power, and another controller configured to generate the zero crossing interrupt signal based on a detected signal.

5. The small home appliance of claim 4, wherein the wireless power transmission device further comprises: an antenna for communication, and another communication unit to communicate with the communication unit through the antenna.

6. The small home appliance of claim 5, wherein the wireless power transmission device further comprises: a zero crossing detector to output the detected signal based on detecting a zero crossing of the commercial power.

7. The small home appliance of claim 1, wherein the zero crossing interrupt signal is a square wave signal having a period of 8.3 ms.

8. The small home appliance of claim 7, wherein the zero crossing interrupt signal has a pulse width of 2 ms.

9. The small home appliance of claim 1, wherein the small home appliance comprises an electric kettle, a blender, and a toaster.

10. A method for performing communication between a small home appliance comprising a coil for power reception and communication and a wireless power transmission device, the method comprising:
transmitting, by the wireless power transmission device, a zero crossing interrupt signal related to wireless power to the small home appliance when the wireless power transmission device transmits the wireless power;
receiving, by the small home appliance, the zero crossing interrupt signal; and
determining, by the small home appliance, a communication period for communication using the coil based on the zero crossing interrupt signal.

11. The method of claim 10, wherein the determining the communication period comprises controlling, by the small home appliance, a switch based on the zero crossing interrupt signal.

12. The method of claim 10, wherein the determining the communication period comprises:
generating, by the small home appliance, a communication control signal based on the zero crossing interrupt signal;
transmitting, by the small home appliance, the communication control signal to a communication unit of the small home appliance; and
operating, by the communication unit of the small home appliance, based on the communication control signal.

13. The method of claim 10, further comprising:
detecting a zero crossing of commercial power, by the wireless power transmission device, when the wireless power transmission device transmits wireless power using the commercial power, and
generating, by the wireless power transmission device, the zero crossing interrupt signal based on the detected zero crossing.

14. The method of claim 10, wherein the zero crossing interrupt signal is a square wave signal having a period of 8.3 ms.

15. The method of claim 10, wherein the zero crossing interrupt signal has a pulse width of 2 ms.
